(19) United States
(12) Patent Application Publication
(10) Pub. No.: US 2002/0087360 A1
(43) Pub. Date: Jul. 4, 2002

(54) Immunization tracking method

(76) Inventor: Stephen W. Pettit, Suwanee, GA (US)

Correspondence Address: Kenneth S. Watkins, Jr., 372 River Drive, Dahlonega, GA, 30533, US

(21) Appl. No.: 09/753,910

(22) Filed: Jan. 2, 2001

(51) Int. Cl. G06F 17/60

(52) U.S. Cl. 705/3

(57) ABSTRACT

An immunization-tracking method utilizes machine-readable devices such as bar code stickers 103A containing immunization product data to immunization product packaging 105A. An immunization provider 101A uploads the immunization product data from a reader 115A to a provider computer 117A. Individual identification data, date of immunization, and dose are entered at the time of immunization to provide an immunization tracking file in computer 117A. Immunization provider computers 117A, 117B and 117C are connected to an immunization-tracking network for processing by a network host computer by an immunization-tracking authority 102.

### FIELD OF THE INVENTION

The present invention relates to medical event tracking methods and, more specifically, to immunization-tracking methods for individuals utilizing machine-readable immunization data devices.

### BACKGROUND OF THE INVENTION

Immunization tracking is an area of high public interest. Current methods vary considerably from area to area, creating difficulties in maintaining accurate records. This is a problem with infants and school-aged children, especially when moving to another locality or school and documentation of immunization is not available or is not compatible with the new location. Documentation and tracking of immunization by locality, age groups or the entire population is difficult if not impossible with current methods.

Another problem with current methods is identifying and providing effective corrective action to adverse immunization reactions and defective immunization products. Although methods are in place to identify adverse reactions, there is no satisfactory method to ensure all individuals at risk are identified and notified. The lack of good documentation and tracking reduces the effectiveness of methods of identifying adverse reactions to immunization products.

U.S. Pat. No. 5,865,470 discloses a peel-off coupon and card used to track the immunization record for a child. The card has a series of coupons having bar codes that represent the required vaccination shots needed by a child. The card is presented to a doctor at the time of vaccination. The doctor would remove the peel-off coupon and place it on a tracking sheet for tracking purposes. U.S. Pat. No. 5,673,944 discloses a business form for use at record receiving locations. The record ply of the form includes immunization data for tracking purposes.

None of the current methods provide a convenient and reliable method to track immunizations that is convenient, provides a wide variety of tracking features, and is easily standardized for immunization providers.

### OBJECTS AND SUMMARY OF THE INVENTION

Therefore, an object of the present invention is to provide a an immunization-tracking method which utilizes machine-readable devices on immunization product packaging in a tracking system which is convenient, provides a wide variety of tracking features, and is easily standardized for immunization providers.

Another object of the present invention is to provide an immunization-tracking method that provides accurate tracking of immunized groups by immunization product, age groups, and geographical areas.

Another object of the present invention is to provide an immunization-tracking method that provides accurate tracking of adverse reactions to immunization products.

Another object of the present invention is to provide an immunization-tracking method that provides a means to identify at-risk individuals of immunizations.

Another object of the present invention is to provide an immunization-tracking method that provides feedback to immunization product manufacturers.

Another object of the present invention is to provide an immunization-tracking method that provides immunization-tracking files to a network operable by an immunization-tracking authority.

Yet another object of the present invention is to provide an immunization-tracking method that provides security for personal information and data.

The immunization tracking system of the present invention comprises the steps of attaching a machine-readable communications device such as a bar code sticker, magnetic strip or microprocessor chip to immunization product packaging at the time of manufacture and before shipping form the manufacturer's location. The machine-readable communications devices contain encoded data representing immunization product identification, lot or batch number, product expiration date and, optionally, immunization dosage, adverse reaction warnings, and other data as appropriate.

Immunization providers such as hospitals or clinics utilize machines such as bar code readers or magnetic strip readers to upload the immunization product data on the immunization product packaging in the memory of a computer located at the immunization provider location, preferable at or near the time of immunization. At the time of immunization, additional data including patient identification data, administration date and time, and administered dose is entered into the provider's computer to create an immunization-tracking file. In the preferred embodiments, the provider's computer is connectable to a network, such as an immunization-tracking network comprising other immunization provider computers and a host computer operated by an immunization-tracking authority. In other embodiments, immunization product manufacturer's computers are also accessible to the network.

The immunization-tracking network allows the immunization-tracking authority to track immunization by geographical area, age groups, or other groups desired. The immunization-tracking authority may also track adverse-reactions to immunizations and defective immunization products and notify at-risk groups, individuals or immunization product manufacturers directly or though the immunization providers, depending on security firewalls provided by the network.

In other embodiments, the tracking method provides personal immunization-tracking “smart cards” carried by individuals. The personal immunization cards contain the personal immunization data that can be uploaded, and updated by, the immunization provider at the time of immunization.

### BRIEF DESCRIPTION OF THE DRAWINGS

These and other features, aspects and advantages of the present invention will become better understood with regard to the following description, appended claims and accompanying drawings where:

FIG. 1 is a block diagram showing the steps of the immunization-tracking method of the present invention and an immunization-tracking network for sharing immunization-tracking files;

FIG. 2 is a block diagram of the immunization-tracking network of FIG. 1 showing security features of the network and personal immunization cards that interface with the immunization provider computers;

FIG. 3A is a perspective drawing of a syringe with an attached bar-code sticker for use with the immunization-tracking method of the present invention;

FIG. 3B is a perspective drawing of a syringe with an attached magnetic strip for use with the immunization-tracking method of the present invention;

FIG. 3C is a perspective drawing of a medical bottle with an attached bar-code sticker for use with the immunization-tracking method of the present invention; and

FIG. 3D is a perspective drawing of an immunization vial with an attached magnetic strip for use with the immunization-tracking method of the present invention.

### DESCRIPTION OF THE PREFERRED EMBODIMENTS

The following is a description of the preferred embodiments of an immunization-tracking method utilizing machine-readable devices on the product packaging.

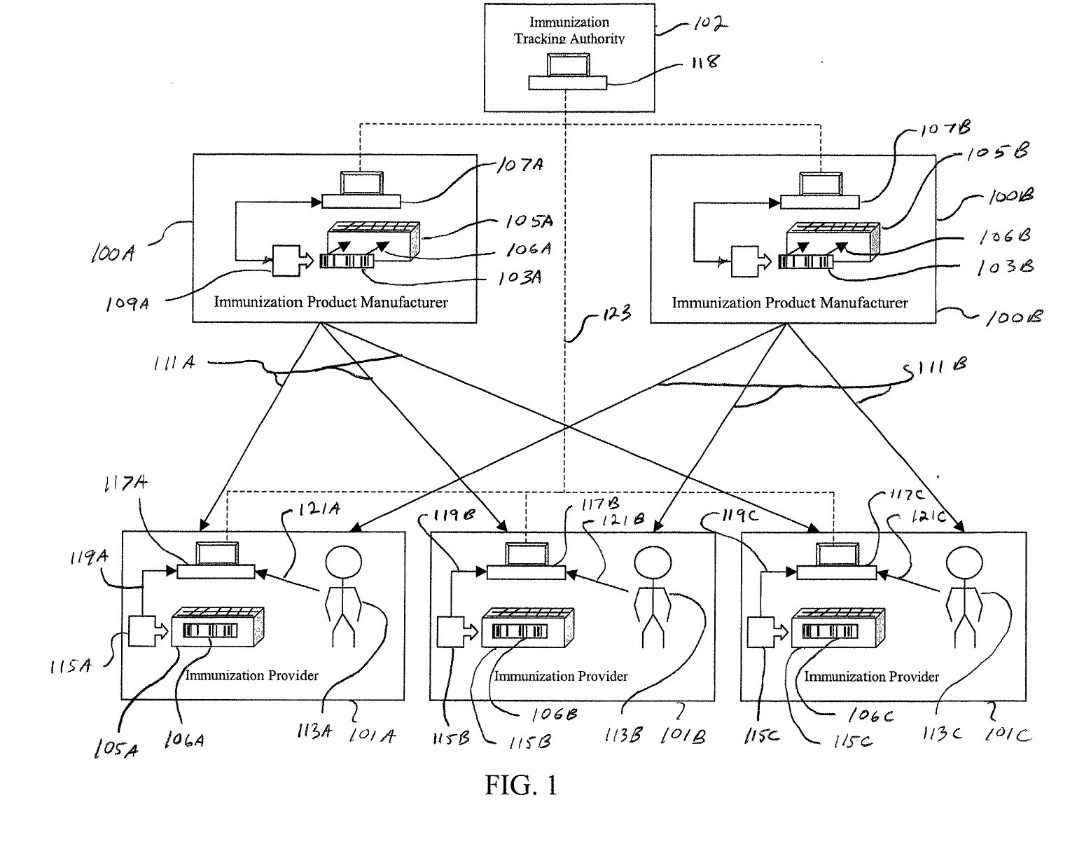

FIG. 1 is a block diagram of the preferred embodiment of an immunization-tracking method for immunization product manufacturers 100A, 100B, immunization providers 101A, 101B, 101C, and immunization-tracking authority 102. For simplicity, the following method descriptions are written for immunization product manufacturer 100A, and immunization provider 101A, although the method, hardware and software for the other manufacturers and providers is similar.

The method shows the attaching a machine-readable communications device such as a bar code sticker 103A on immunization product packaging 105A in step 106A at immunization product manufacturer location 100A. Immunization product packaging may be packaging for individual immunization-containing products or components such as vials or syringes or the immunization product packaging may be cartons, boxes or connected strips of immunization-containing components. In other embodiments, other machine-readable communications devices may be attached to immunization product packaging such as magnetic strips, “smart” chips such as microprocessors, etc.

In the preferred embodiments the immunization product data encoded onto bar code sticker 103A includes:

immunization product identification such as generic or chemical name of the product;

manufacturer identification;

product lot number; and

product expiration date.

In other embodiments, utilizing machine-readable communications devices having sufficient non-volatile memory, the immunization product data encoded on the device also includes product manufacturing date, dose size, administering requirements and instructions, and product warnings such as possible allergic responses.

In the preferred embodiments, a manufacturer's computer 107A provides a method to input and download the immunization product data to bar code sticker 103A through an up-load/download device such as bar code sticker printer/reader 109A. Manufacturer's computer 107A maintains a file in its memory of all immunization product data encoded on bar code sticker 103A.

Immunization product packaging 105A containing the machine-readable bar-code sticker 103A is shipped to immunization provider 101A in step 111A for immunizing individuals 113A. After receipt and, preferable at the time of immunization or administration, the immunization product data on bar code sticker 103A of immunization product packaging 105A is read or uploaded by bar code reader 115A to provider's computer 117A in step 119A.

Individual immunization data on individual 113A is also entered into provider's computer 117A in step 121A at approximately the time of administration. Individual immunization data includes at least one data entry relating to identification of the individual being immunized. In the preferred embodiments, the individual immunization data is traceable to the specific individual and may include the individual's name, social security number, medical insurance number, or other data traceable to the individual. In the preferred embodiments, the individual immunization data also includes the time and date of administration, age of the individual and, optionally, additional medical, insurance, or other information useful in tracking and analyzing immunizations.

The combination of immunization product data uploaded to provider's computer 117A in step 119A and individual immunization data entered or uploaded in step 121A provides the data necessary for a provider immunization-tracking file maintained on provider's computer 117A. In the preferred embodiments, the provider immunization-tracking file on provider's computer 117A is accessible to network host computer 118 of immunization-tracking authority 102 by immunization-tracking network 123. In the preferred embodiments, the immunization-tracking files on immunization provider computers 117B, 117C are also accessible to immunization-tracking authority 102. In the most preferred embodiments, manufacturer's immunization product files on manufacturer's computers 107A, 107B are accessible to immunization-tracking authority 102 via network 123.

The ability of immunization-tracking authority 102 to access provider immunization-tracking files and, optionally, manufacturer's immunization product tracking files via network 123 allows software residing on network host computer 118 to process immunization tracking. For example, the network host could query the provider immunization-tracking files to determine the total number of immunized individuals for a given immunization product or, alternatively, the number of immunized individuals from traceable groups such as geographic residence, age, race or other desired groupings.

The tracking method of the present invention would also allow tracking of immunization problems such as allergic reactions by querying the provider immunization-tracking files. The method also allows tracking individuals receiving defective immunization products by identifying individuals through identified defective immunization products and/or lot numbers. At-risk individuals could be identified and contacted by the tracking authority or, alternatively, the immunization provider if individual identification data is maintained within the provider immunization tracking file for personal security reasons.

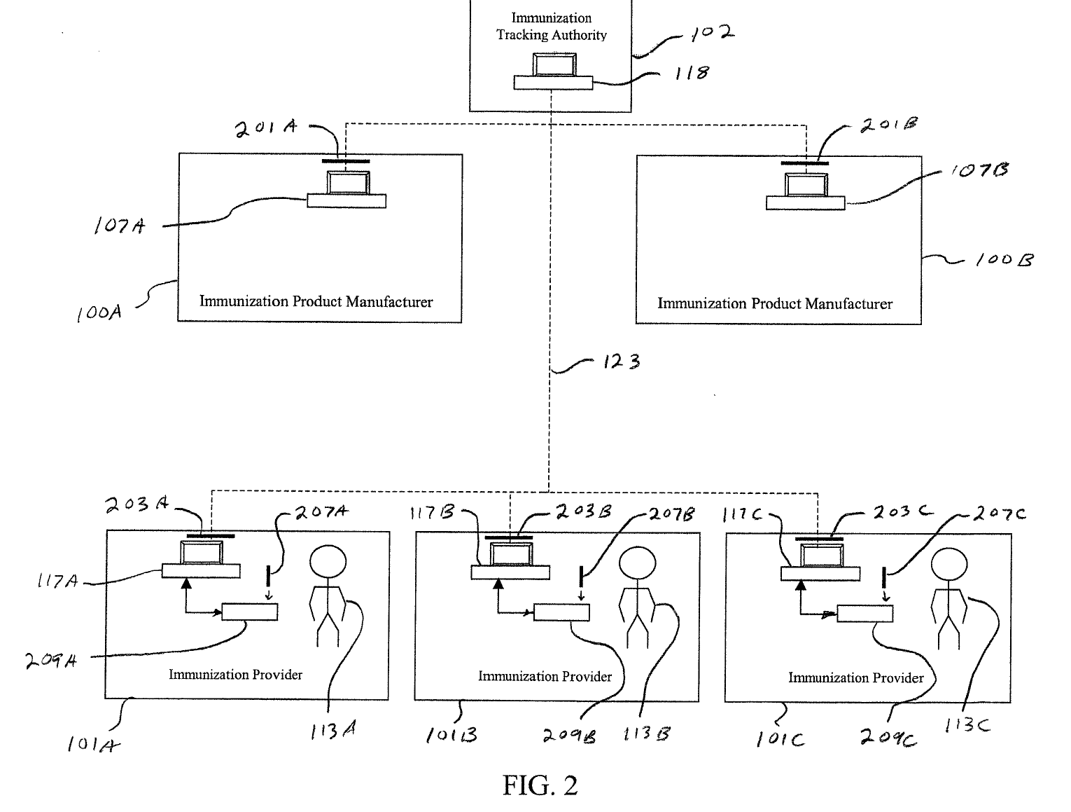

FIG. 2 is a block diagram of immunization-tracking network 123 showing operational and security features of the preferred embodiments of the present invention. Firewalls 201A, 201B at the immunization product manufacturers 100A and 100B and firewalls 203A, 203B, 203C at immunization providers 101A, 101B and 101C provide security by preventing unauthorized access to immunization-tracking files or other information residing on the respective computers. The firewalls may be physical hardware or password-protected software that restricts data flow to that authorized by the immunization-tracking authority or, alternatively, the respective resident user.

For example, the firewalls may be configured so that the immunization-tracking authority can upload immunization-tracking files from the respective immunization providers though firewalls 203A, 203B and 203C, but the immunization providers would not have access through the firewalls to immunization-tracking files residing with other immunization providers. Or, firewalls 201A and 201B may allow only specific tracking files containing no personal identification information into manufacturers computers 107A, 107B.

Another embodiment of the present invention provides personal immunization records maintained on personal immunization cards 207A, 207B, 207C. These cards could be dedicated “smart cards” containing a microprocessor for storing the personal immunization records, or they may be an immunization tracking record portion kept on personal medical record smart cards known in the art. In the preferred embodiments, the personal immunization records maintained on the cards would contain the immunization product identification, lot number, and date administered of all immunizations administered to the individual 113A, 113B, 113C. Additional, or all of, the immunization data of the provider immunization tracking file discussed previously could be downloaded onto personal immunization cards 207A, 207B, 207C.

Personal immunization card reader/writers 209A, 209B 209C provide a means to upload the personal immunization record for the individual when the individual arrives at the immunization provider for verification of the current immunization status of the individual. After immunization, an updated immunization record would be downloaded onto the individual's personal immunization card 207A by the respective reader/writer. In a preferred embodiment, reading, or optionally writing to, the personal immunization cards would require entering of a personal identification number (PIN) of the individual to provide personal security.

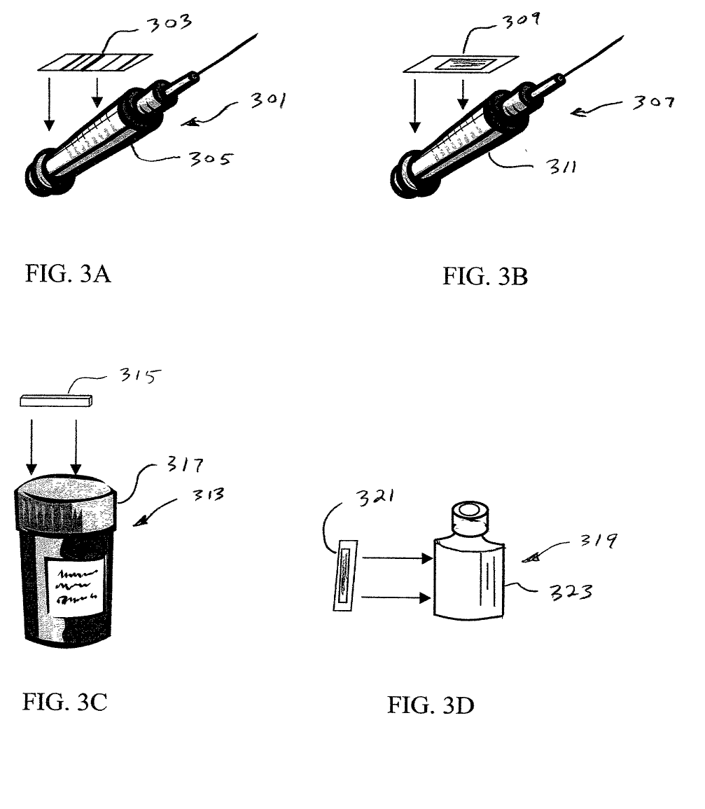

FIG. 3A is a perspective drawing of a syringe 301 used for immunization having a machine-readable bar-code sticker 303 placed on the body 305 of syringe 301. Bar-code sticker 303 may be attached by an adhesive such as a pressure sensitive adhesive, hot melts, cold melts, or adhesive strips.

FIG. 3B is a perspective drawing of a syringe 307 used for immunization having a machine-readable magnetic strip 309 placed on the body 311 of syringe 307. Magnetic strip 309 may be attached by an adhesive such as a pressure sensitive adhesive, hot melts, cold melts, or adhesive strips.

FIG. 3C is a perspective drawing of a bottle 313 used for immunization having a machine-readable microchip 315 attached on the cap 317 of bottle 313. Microchip 315 may be attached by an adhesive such as a pressure sensitive adhesive, hot melts, cold melts, or adhesive strips.

FIG. 3D is a perspective drawing of a vial 319 used for immunization having a machine-readable magnetic strip 321 attached to body 323 of vial 319. Magnetic strip 321 may be attached by an adhesive such as a pressure sensitive adhesive, hot melts, cold melts, or adhesive strips.

Accordingly, the reader will see that immunization-tracking method provides a flexible and reliable method for tracking immunizations from a number of immunization providers. The device provides the following additional advantages:

The method provides accurate tracking of immunized groups by immunization product, age groups, and geographical areas;

The method provides accurate tracking of adverse-reactions to immunization products;

The method provides a means to identify at-risk individuals of immunizations;

The method provides feedback to immunization product manufacturers;

The method provides immunization-tracking files to a network operable by a immunization-tracking authority and

The method provides security for personal information and data.

Although the description above contains many specifications, these should not be construed as limiting the scope of the invention but merely providing illustrations of some of the presently preferred embodiments of this invention. For example, the tracking method may be used as input to the patient's medical file, billing files and insurance files. Thus the scope of the invention should be determined by the appended claims and their legal equivalents, rather than by the examples given.

I claim:

1. A method of tracking immunizations by use of machine-readable communications devices, the method comprising the steps of:
attaching a machine-readable communications device on an immunization product package, the communications device comprising machine-readable data including immunization product identification, manufacturer identification, immunization product lot number, and manufacturing date;
entering at least a portion of the machine-readable data read by a machine from the machine-readable communications device on the immunization product package to a computerized immunization-tracking file at an immunization provider location; and
entering patient identification and administration date on the immunization-tracking file generally at the time of administration.

2. The method of tracking immunizations of claim 1 comprising the additional step of providing the immunization-tracking file on a network to define a computerized immunization tracking system comprising a plurality of computerized immunization-tracking files accessible from a plurality of immunization provider locations.

3. The method of tracking immunizations of claim 1 wherein the machine-readable data includes immunization dose.

4. The method of tracking immunizations of claim 1 wherein an administered dose is entered on the immunization tracking file generally at the time of administration at the immunization provider location.

5. The method of tracking immunizations of claim 1 wherein the machine-readable device comprises a bar code attached to the immunization product packaging.

6. The method of tracking immunizations of claim 1 wherein the machine-readable device comprises a magnetic strip attached to the immunization product packaging.

7. The method of tracking immunizations of claim 1 wherein the machine-readable device comprises a microprocessor attached to the immunization product packaging.

8. The method of tracking immunizations of claim 1 wherein the immunization product packaging is a vial.

9. The method of tracking immunizations of claim 1 wherein the immunization product packaging is a package comprising a plurality of vials.

10. The method of tracking immunizations of claim 1 wherein the immunization product packaging is a syringe.

11. The method of tracking immunizations of claim 1 wherein the immunization product packaging is a package comprising a plurality of syringes.

12. The method of tracking immunizations of claim 1 wherein at least a portion of the immunization-tracking file is uploaded into a computerized patient file maintained at a medical provider facility.

13. The method of tracking immunizations of claim 1 wherein at least a portion of the immunization-tracking file is uploaded into a computerized patient-billing file maintained at a medical provider facility.

14. The method of tracking immunizations of claim 1 wherein at least a portion of the immunization-tracking file is uploaded into a computerized patient medical insurance file maintained at a medical provider facility.

15. The method of tracking immunizations of claim 1 wherein the communications device comprising machine-readable data is attached to the immunization product packaging at an immunization product manufacturer's location.

16. The method of tracking immunizations of claim 2 wherein the network is assessable by an immunization-tracking authority comprising a computer facility connected to the network for retrieving and processing of said plurality of computerized immunization-tracking files on the network.

17. A method of tracking immunizations by use of machine-readable communications devices, the method comprising the steps of:
attaching a machine-readable communications device on an immunization product package, the communications device comprising machine-readable data including immunization product identification, manufacturer identification, immunization product lot number, and manufacturing date;
entering at least a portion of the machine-readable data read by a machine from the machine-readable communications device on the immunization product package and additionally entering patient identification and administration date to define a provider's immunization-tracking file on a provider's computer at an immunization provider location.

18. The method of tracking immunizations of claim 17 comprising a plurality of provider's computers connected to an immunization-tracking network, said plurality of provider's computers comprising a plurality of provider's immunization-tracking files.

19. The method of tracking immunizations of claim 18 wherein the immunization-tracking network is accessible by an immunization-tracking authority comprising a computer facility connected to the immunization-tracking network for retrieving and processing of said plurality of provider's immunization-tracking files on the immunization-tracking network.

20. The method of tracking immunizations of claim 19 comprising a manufacturer's immunization product file comprising the machine-readable data on a manufacturer's computer, the manufacturer's computer being connected to the immunization-tracking network accessible by the immunization-tracking authority.
